(19) United States
(12) Patent Application Publication
(10) Pub. No.: US 2023/0007946 A1
(43) Pub. Date: Jan. 12, 2023

(54) SYSTEM AND METHOD FOR MANAGING SELF-DIRECTED INVESTMENT ACCOUNTS

(71) Applicant: Jeffrey Nabers, Scottsdale, AZ (US)

(72) Inventor: Jeffrey Nabers, Scottsdale, AZ (US)

(21) Appl. No.: 17/858,190

(22) Filed: Jul. 6, 2022

Related U.S. Application Data
(60) Provisional application No. 63/218,591, filed on Jul. 6, 2021.

(51) Int. Cl. G06Q 40/06; G06Q 30/00

(52) U.S. Cl. CPC G06Q 40/06; G06Q 30/018

(57) ABSTRACT

A system for combining a plurality of financial services in a single investment application for checkbook-controlled retirement plans is disclosed. At least one device is in operable connection with a network. An application server is in operable communication with the network and is configured to host an application system displaying financial information for interacting with a plurality of financial services. The application system having a user interface module for providing access to the application system to the at least one device. The user interface in operable communication with a compliance database to interact with a compliance module. An integration module integrates the plurality of financial services and a funds transfer module to initiate and execute a transfer of funds between one or more of the plurality of financial services.

### CROSS REFERENCE TO RELATED APPLICATIONS

The present application claims priority to U.S. Provisional Patent Application No. 63/218,591 filed Jul. 6, 2021, entitled “SYSTEM AND METHOD FOR MANAGING SELF-DIRECTED INVESTMENT ACCOUNTS” which is hereby incorporated by reference in its entirety.

### FIELD

The present disclosure relates to a system and method for self-directed investing; and more particularly, to a system and method for establishing, conducting, tracking, and managing checkbook-controlled retirement plans and their related accounts, entities, structures, investments, transactions, records, third party professional advisors, and compliance filings related to conventional and alternative investments.

### BACKGROUND

Investing in a mix of conventional and alternative investments in a mix of taxable and retirement accounts has been a difficult, confusing, and risky process. It has required an investor to assemble his own system of identifying investments, performing due diligence, forming investment entities, funding investments, and managing and tracking investments. This convoluted and disintegrated process has involved each investor finding or acquiring various knowledge, tools, parties, and service providers. This has been a piecemeal process with each investor largely having to “reinvent the wheel” for themselves.

While securities brokerages often label their accounts “self-directed,” this is in conflict of the meaning herein of a self-directed retirement structure. For our purposes a self-directed retirement structure, or “checkbook-controlled retirement plan,” is one that is able to invest directly into alternative investments—such as cryptocurrencies, private placements, real property, precious metals, startups, etc.—in addition to conventional assets such as securities, in a tax favored retirement plan described in Internal Revenue Code Section 408, 401, or any other defined contribution or defined benefit retirement plan that may cover individuals, their spouses, and owner-employee partners in their business. These include a self-directed IRA, “checkbook” IRA, IRA LLC, self-directed 401k, solo 401k, checkbook 401k and similar structures.

### SUMMARY

A system for combining a plurality of financial services for at least one checkbook-controlled retirement plan, accessible through a single login, is disclosed. At least one device is in operable connection with a network. An application server is in operable communication with the network and is configured to host an application system displaying financial information for interacting with a plurality of financial services. The application system having a user interface module for providing access to the application system to the at least one device. The user interface in operable communication with a compliance database to interact with a compliance module. An integration module integrates the plurality of financial services and a funds transfer module to initiate and execute a transfer of funds between one or more of the plurality of financial services.

In one aspect, the embodiments relate to establishing, conducting, tracking, and managing at least one checkbook-controlled retirement plan, as well as taxable entities, structures, accounts, transactions, and compliance filings related to conventional and/or alternative investments. The system provides technological improvements in the areas of establishing and maintaining new investments, integrating third-party software products, providing marketplaces for third-party advisors and private investments, licensing and white label customization of the system, and investment compliance.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

The features and advantages of the present disclosure will be more fully described in, or rendered obvious by the following detailed description of the preferred embodiments, which are to be considered together with the accompanying drawings wherein like numbers refer to like parts and further, wherein:

FIG. 1 is a block diagram of a computing system, in accordance with some embodiments described herein;

FIG. 2 is a block diagram of a computing system and an application program, in accordance with some embodiments described herein;

FIG. 3 is a further block diagram of the application program of FIG. 2;

FIG. 4A is a flowchart of a compliance process, in accordance with some embodiments described herein;

FIG. 4B is a flowchart of a compliance process, in accordance with some embodiments described herein;

FIG. 5 is a flowchart of a schematic of the funds flow architecture, in accordance with some embodiments described herein;

FIG. 6 is a flowchart of a process for initiating a user account, in accordance with some embodiments described herein;

FIG. 7 is a diagram of account access architecture in accordance with the prior art;

FIG. 8 is a diagram of a account access architecture in accordance with some embodiments described herein; and

FIG. 9 is a block diagram of the retirement plan structures system in accordance with some embodiments described herein;

FIG. 10A is a map of frontend and backend connections between the application program of FIG. 2 and external systems; and

FIG. 10B is a map of frontend and backend connections between the application program of FIG. 2 and external systems.

### DETAILED DESCRIPTION

Reference will now be made in detail to the present preferred embodiment(s), and examples of which is/are illustrated in the accompanying drawings. Whenever possible, the same reference numerals will be used throughout the drawings to refer to the same or like parts. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure.

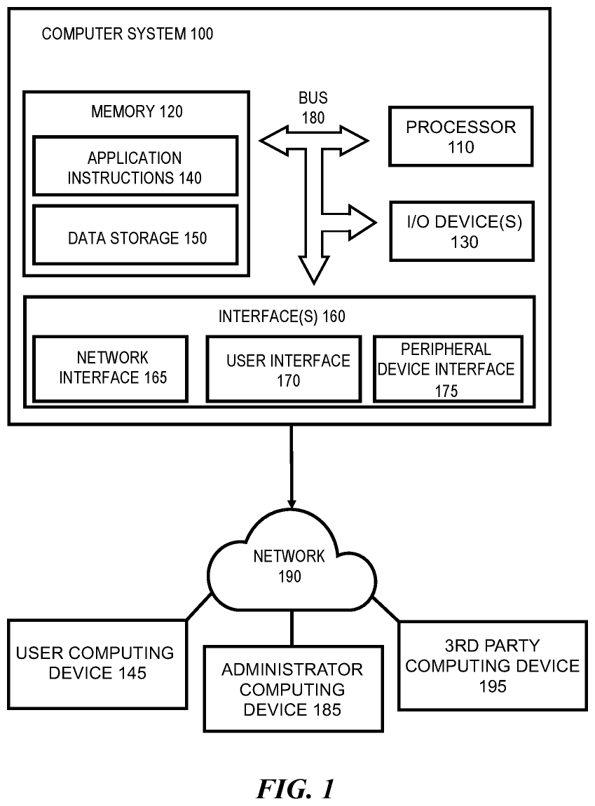

In various embodiments, a computer implemented method and system configured to execute instructions for performing the method are provided. As shown in FIGS. 1-8, the embodiments in this disclosure generally relate to establishing, conducting, tracking, and managing a checkbook-controlled retirement plan, as well as taxable entities, structures, accounts, transactions, and compliance filings related to conventional or alternative investments. In various embodiments, the system and method disclosed herein provide technological improvements in the areas of establishing and maintaining new investments, integrating third-party software products, providing a marketplace for third-party advisors, licensing and white label customization of the system, and investment compliance.

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “conventional investments” refers to cash, stocks, and bonds, index funds, exchange traded funds and any publicly traded securities, and the term “alternative investments” refers to assets other than cash, stocks, bonds, index funds, exchange traded funds and publicly traded securities. In some embodiments, the term “alternative investments” comprises real estate, precious metals, business entities, cryptocurrency, and any other assets not prohibited by law.

As used herein, a “self-directed” retirement structure is configured for a user to directly invest in an alternative investment, in a tax favored retirement plan described in Internal Revenue Code (IRC) Section 408, IRC Section 401, or any other defined contribution or defined benefit retirement plan that may cover individuals, their spouses, and owner-employee partners in their businesses. Such plans include self-directed IRA, checkbook IRA, IRA LLC, self-directed 401k, solo 401k, checkbook 401k, and similar structures.

One type of self-directed retirement plan is offered and provided by a self-directed custodian, such as a bank, trust company, or third-party administrator (TPA) associated with a bank or trust company. Such custodians and TPAs hold and administer the assets of the retirement plan directly, for the benefit of the individual investor account holder. In such a Self-Directed IRA Custodian Account, the investor directs the custodian, or the TPA, to make investments, usually through a written direction-of-investment form. The investor must rely on the custodian to process the investment transaction and sign investment documents on their behalf.

Another self-directed retirement plan is the IRA LLC or Checkbook IRA. Such a plan involves the opening of a self-directed IRA account with a self-directed IRA custodian as well as the creation of a newly formed limited liability company (LLC). The IRA must be held with a custodian as defined in IRC 408. The LLC has a single member and owner, which is the self-directed IRA. The LLC is managed by the owner of the self-directed IRA.

Another self-directed retirement plan structure is the Solo 401k. This type of self-directed retirement plan is specifically for a person who owns a business, whether structured as a sole proprietorship, LLC, S Corp, C Corp, or limited partnership, having no non-owner employees who work 1000 hours per year or more and receive W2 wages. The owners and their spouses are able to participate in the Solo 401k plan adopted by the small business. With a Solo 401k, a custodian, such as a bank or trust company, can be appointed but is optional. Under IRC 401, there is no requirement for a third-party administrator. Further there is no requirement for the trust role to be assigned to a custodian. As such, many investors who pursue alternative investments often choose to name themselves as administrator and/or trustee of their Solo 401k plan. The entity holding the assets is often a trust as named in the 401k plan documents, including the Adoption Agreement and Summary Plan Description Documents.

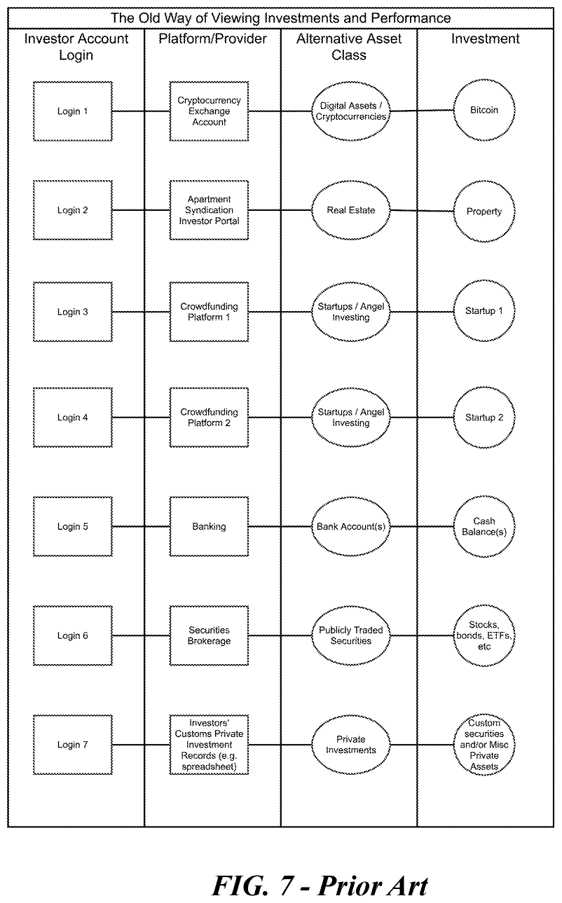

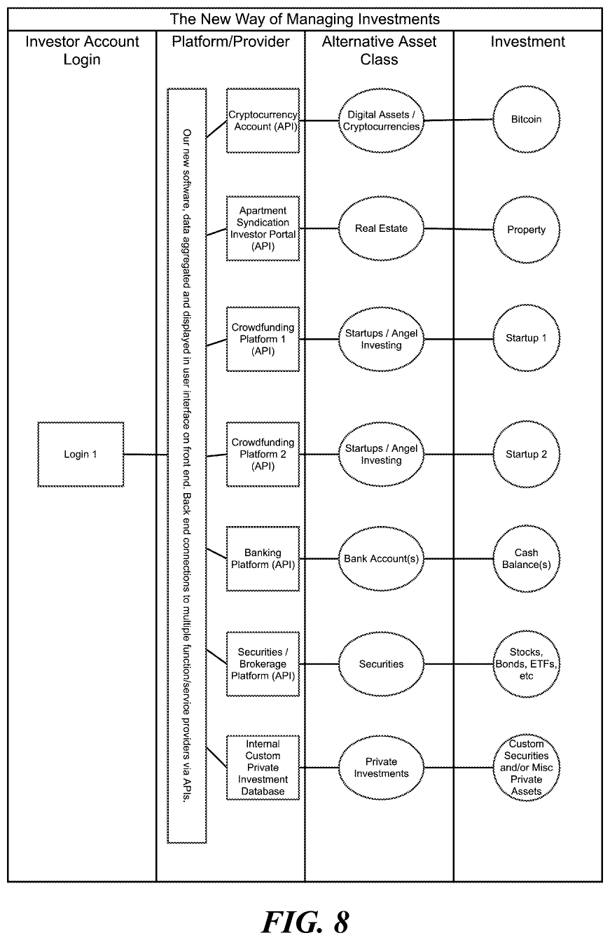

As would be appreciated by one skilled in the art, investing in a mix of conventional and alternative investments in a mix of retirement and taxable accounts has traditionally required an investor to assemble their own system to identify investments, perform due diligence, form investment entities, fund investments, and manage and track investments. For example, as shown in FIG. 7, an investor seeking to invest in a plurality of alternative investments, including Bitcoin, real property, and a startup company, must create a separate account for each investment, and each account is administered on a separate platform. In such an example, the investor must proceed through the same or similar processes for each investment and platform before the investment can be executed. As a result of this process, investors risk a multitude of errors that could cause costly mistakes. These costly mistakes can include errors in tax filings, errors in processing an estate upon the investor's death, lost cryptocurrency keys, and other costly problems. FIG. 7 illustrates the prior art, while FIG. 8 demonstrates how an investor can access multiple providers, platforms, asset classes, and investments from a single login.

In reference to FIG. 8, an investor account login is in communication with various platforms/providers. The system reads data aggregated from platform/providers and displays data in the user interface on the front end of the system. The platform/providers may include, for example cryptocurrency accounts (API), apartment syndication investor portals (API), brokerage accounts (API), bank accounts (API) and crowdfunding platforms (APIs) each involving one or more conventional or alternative investments. In some embodiments, alternative assets/investments may be combined with conventional assets/investments. Further, conventional assets may be used without the inclusion of alternative assets. Alternative assets may, for example, include digital assets, cryptocurrencies, real estate assets, startups and/or investing assets and the like. Conventional assets may, for example, include bank accounts, securities and the like. The alternative assets and/or conventional assets may be transmitted to investments including cryptocurrencies, property, private loans, private funds, securities, bank accounts and startups with which the investor invests in. In such, the single login is used to access the plurality of services provided by the various API partners (i.e., cryptocurrency accounts (API), apartment syndication investor portals (API), brokerage accounts (API), bank accounts (API) crowdfunding platforms (APIs), and the like). This creates an efficient and simplified platform for a user to utilize a single login to access the data and investment functions, such as sending orders for execution for a buy order, sell order, exchange, or swap, that operate with the support of each API partner.

In various embodiments, the application program 200 provides several advantages over existing processes for investing in conventional and alternative investments. In one aspect, the application program 200 provides a system that integrates the elements listed above (e.g., identifying investments, perform due diligence, form investment entities, fund investments, and manage and track investments). Through the integration of such processes into the application program 200, the complexities associated to each individually are abstracted away. In some embodiments, a plurality of investment options is systematically integrated using application programming interfaces (APIs). In such embodiments, each investment option can access a users previously-performed Know Your Client (KYC) and/or Know Your Business (KYB) compliance processes and documentation collection. Each separate investment can satisfy its compliance requirements and procedures programmatically (i.e., automatically or substantially automatically), thus reducing account-opening processing time and eliminating the need for an investor to repeatedly send the same documentation to multiple parties via mail, email, fax, or various separate online portals. In some embodiments, the elimination of duplication of efforts relating to data entry and document transport is a significant advantage of the application program 200 because processes that usually take weeks or months to accomplish can now be completed in minutes with minimum user effort. Additionally, the risk of compliance violations and various other errors is substantially minimized or eliminated.

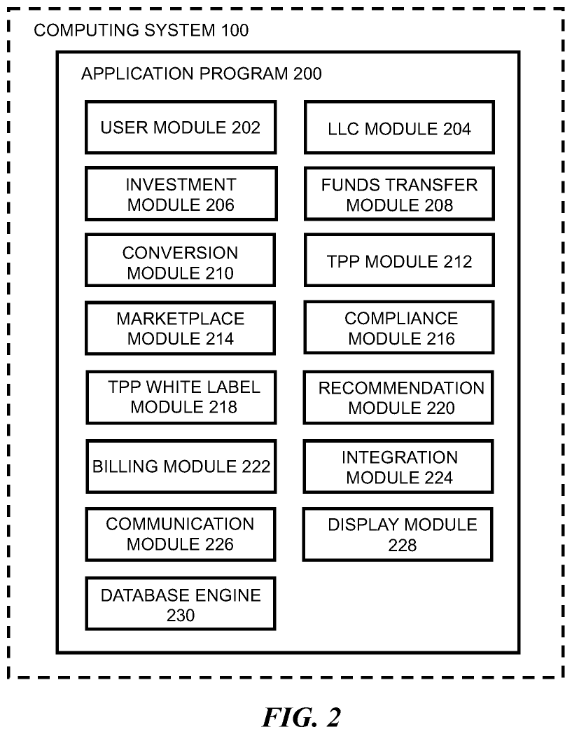

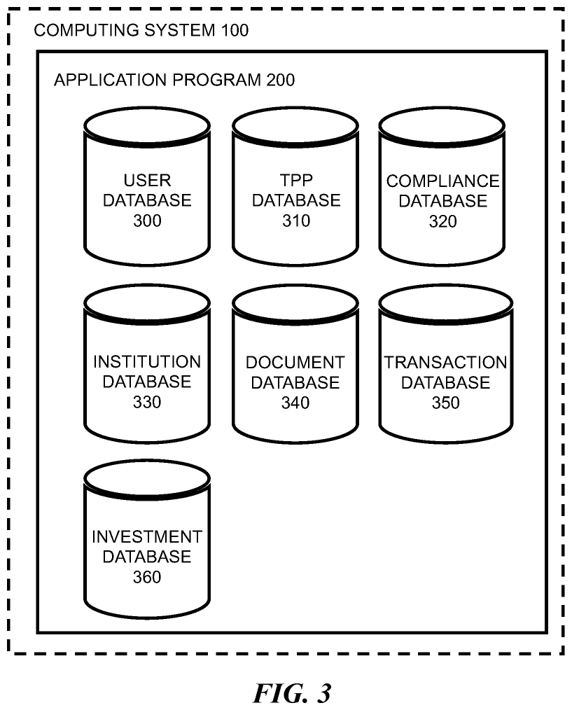

FIGS. 2 and 3 illustrate an example computer architecture for the application program 200 for establishing, conducting, tracking, and managing checkbook-controlled retirement plan, as well as taxable entities, structures, accounts, transactions, and compliance filings related to conventional and alternative investments. As shown in FIGS. 2 and 3, the computer system 100 comprises several modules and engines configured to execute the functionalities of the application program 200, and a database engine 230 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the application program 200 comprises one or more modules having the necessary routines and data structures for performing specific tasks, and one or more engines configured to determine how the platform manages and manipulates data. In some embodiments, the application program 200 comprises one or more of a user module 202, an LLC module 204, an investment module 206, a funds transfer module 208, a conversion module 210, a third-party professional (TPP) module 212, a marketplace module 214, a compliance module 216, a TPP white label module 218, a recommendation module 220, a billing module 222, an integration module 224, a communication module 226, a display module 228, and a database engine 230.

In some embodiments, the user module 202 is configured to facilitate the creation of a user account for an investor. In some embodiments, when an investor user inputs personal or identifying information into the application program 200, such as their name, email, phone, address, social security number, driver's license number and/or photocopy thereof, proof of residence document, etc., the information (data) is saved in the user database 300 for later use. Accordingly, in such embodiments, the investor will not need to reenter such information and duplicative data entry is eliminated. In such embodiments, any forms, including compliance documents required when opening a new investment, that require personal or related information will be automatically entered by the system with the saved information in the user database 300.

In some embodiments, the user module 202 is configured to allow an investor to share their investment information with one or more third party professionals. For example, the investor can define the sharing permissions for one or more specified third-party professionals. In some embodiments, the information (e.g., investments) shared by the user module 202 is displayed with read-only viewing capabilities. For example, the setting for the sharing and viewing capabilities can be set on a per entity basis and/or per account basis. In some embodiments, each entity and/or account will have a distinct sharing setting for each third-party professional specified by the investor.

In some embodiments, the LLC (Limited Liability Company) module 204 is configured to facilitate the formation and management of an LLC for a user/investor. In such embodiments, the user information saved in the user database 300 is utilized to complete one or more forms or other paperwork required to an LLC formation. In some embodiments, the LLC module 204 is configured to transmit, in collaboration with the communication module 226, a completed document to the relevant authority for formation (e.g., state Secretary of State).

In some embodiments, the investment module 206 is configured to facilitate the process of making one or more investments. In such embodiments, investment module 206 may facilitate the initiation of investment transactions to purchase assets such as estate, precious metals, cryptocurrencies, equities, private placements, notes, etc. The investment module 206 may use a Direction of Investment (“DOI”) to guide the transaction. The title for assets purchased will be held in the name of the custodian f/b/o Investor IRA. For example, “First Trust Company f/b/o John Doe IRA.”

In some embodiments, the funds transfer module 208 is configured to facilitate the transfer of money from one or more user personal banking accounts to one or more user investment accounts, from one or more user investment accounts to one or more third-party professional accounts, etc. For example, the funds transfer module 208 may make distributions from an IRA, checkbook IRA LLC, or solo 401k funds.

In some embodiments, the conversion module 210 is configured to facilitate the conversion of one or more existing pre-tax accounts or Traditional IRAs to a Roth IRA or Roth subaccount of a 401(k) plan.

In some embodiments, the third-party professional (TPP) module 212 is configured to facilitate the creation of a user account for a third-party professional. The third-party professional can be any relevant professional service provider, including, e.g., accountants, financial advisors, capital raisers, attorneys, investment sponsors, real estate agents, and other related third-party service professionals. In some embodiments, the information entered by a third-party professional in connection with their account, including their name, company name, address, contact details, branding information, etc., is saved in the TPP database 310. In some embodiments, one or more of the TPP account information items is used when outputting reports and other communications to the investor on behalf of third-party professional.

The third-party professional can have one or more clients who are registered as investors with the application program 200. In some embodiments, the third-party professional has a plurality of clients. In such embodiments, each client who has shared their data with the third-party professional will appear in a browsable and searchable client list provided by the TPP module 212. In some embodiments, one or more searching and filtering tools are provided to allow the third-party professional to filter search results by certain attributes, such as client name, existence of a Solo 401k, Solo 401k plan name, Solo 401k trust name, existence of an IRA, existence of a Checkbook IRA, existence of a brokerage account, existence of a cryptocurrency account, existence of a precious metals account, existence of crowdfunding accounts, LLC name, and other useful data points stored in the TPP database 310.

After a third-party professional is registered with the application program 200 and connected with an investor client who has defined their sharing privileges, the third-party professional will be able to view their client's investment data and documents. In some embodiments, when viewing an investor client profile, the third-party professional can view all information permitted by client sharing settings, including, e.g., the data on an IRA, Checkbook IRA, Solo 401k, bank account(s) of such entities, brokerage account(s) of such entities, cryptocurrency accounts of such entities, precious metals accounts of such entities, crowdfunding accounts or such entities, the investment holdings therein, the documents related to such entities, accounts, and investments, and any related data or documents. In some embodiments, the viewable information is read-only, meaning the TPP cannot modify and/or download the displayed client information.

In some embodiments, the TPP module 212 is configured with investment management capabilities. When activated, the system can allow a TPP investment advisor to make investment decisions and transactions on behalf of their investor client. In such embodiments, the TPP is not be able to withdraw funds from any account or conduct any activity that classifies the advisor as a custodian of the assets. When activated, the system can allow a TPP financial advisor to prohibit one or more of their investor clients from completing an investment transaction without prior authorization from the third-party professional. In such embodiments, each investment transaction can be submitted by the investor via his/her user interface to the third-party professional for approval. In some embodiments, the system is activated only for investor clients the third-party professional invited to the system.

In some embodiments, the marketplace module 214 is configured to facilitate business connections between investors and third-party professionals. In some embodiments, the investor can connect one or more of their entities, accounts, and investments with the account of one or more registered TPP users of the application program 200. In some embodiments, the marketplace module 214 is configured to allow an investor to invite a third-party professional to become a registered user of the software in order to view and download data and documents related to the investor's entities, accounts, and investments. As such, the investor is able to assemble his/her team of professionals directly from the software. In this manner, the application program 200 provides a marketplace to find, hire, and work with third-party professionals.

In some embodiments, the compliance module 216 is configured to analyze investment transactions for compliance with the relevant laws and regulations. For example, when transacting in certain investments, without proper guidance and tools, an investor is at risk of violating rules outlined in Internal Revenue Code Section 4975, known as “prohibited transactions.” Severe penalties can be assessed to the investor ranging from a total distribution of his retirement account to a tax amounting up to 115% or more of the amount involved in the prohibited transaction. Accordingly, compliance with the IRS rules is something that investors need help with.

In some embodiments, before initiating an investment transaction, the compliance module 216 will request the investor to complete a questionnaire designed to check the compliance of his proposed investment. In such embodiments, the questionnaire includes questions about the parties involved and the flow of funds, which may generate one or more warnings of Prohibited Transactions (IRC 4975), UBTI, UDFI, and/or any form of UBIT. The compliance module 216 will also provide a setting on the user interface to optionally require this compliance check prior to all transactions or certain types of transactions.

In some embodiments, a third-party professional may be required to conduct analyses such as risk tolerance and investment suitability. In such embodiments, the compliance module 216 is configured to provide the third-party professional with predetermined risk tolerance questionnaires and other investment suitability surveys, and such information can be analyzed by the system to ensure any alternative investments held in client accounts on the platform are in compliance.

In some embodiments, the compliance module 216 is configured to enable a third-party attorney to invite his investor client to complete a series of questions in a transaction survey. In such embodiments, the compliance module 216 will check for compliance issues relating to Prohibited Transactions (IRC 4975) as well as UBTI, UDFI, and UBIT. The compliance module 216 will output an analysis report as a PDF or Word, to the attorney. In some embodiments, the analysis report is configured according to the attorney's brand (e.g., letterhead with any logos). In some embodiments, the compliance module 216 allows the attorney to choose, via his/her user settings, whether the output report will be delivered to the attorney for his manual presentation to the client or to the client directly in the investor-client's user interface.

In some embodiments, the third-party professional white label module 218 is configured to provide white label capabilities for professional service providers including accountants, financial advisors, capital raisers, attorneys, investment sponsors, real estate agents and other such related services providers. The third-party professional white label module 218 may be configured to apply branding and preferences for layout and functionalities to a portal they can offer to their clients and prospects in connection with the delivery of their services.

In some embodiments, the recommendations module 220 is configured to facilitate to generate recommendations for a third-party professional that are delivered to the advisor for download, in formats such as PDF or Word, using the branding and company information provided by the third-party professional during onboarding. In some embodiments, the third-party professional defines particular limits and ranges on allocation recommendations outputs per asset class. For example, the range for Bitcoin allocation recommendations can be set by a third-party professional to 1-5%. In this scenario, the risk tolerance analysis performed by the recommendations module 220 will output the recommendation within that range, according to the investor's risk tolerance score.

In some embodiments, the recommendations module 220 is enables a third-party professional to request the delivery of one or more recommendations directly to his investor client, within the investor user interface. In such embodiments, the third-party professional decides to make a recommendations actionable on the client's part with a “call to action,” such as a button on the user interface stating, “make recommended investment.” Upon clicking the button, the investor is provided guidance on how to make the recommended investment in the recommended amount and account.

In some embodiments, the billing module 222 is configured to enable a third-party professional to open a professional bank account on the platform for the purposes of receiving fee billing on client assets. In such embodiments, the billing module 222 enables the third-party professional to set a billing schedule and choose which assets and accounts to include in their billing. The billing module 222 then enables the advisor to manually or automatically bill their clients according to the billing settings.

In some embodiments, the integration module 224 is configured to provide integrations with various third-party software. In such embodiments, the integration module 224 enables a third-party professional user interface to include various integrations with professional software the third-party professional uses in the course of his business operations.

For example, the third-party professional may use accounting software, such as QuickBooks, Xero, etc. In such embodiments, the integration module 224 provides transaction and account statements pre-formatted for the target accounting software and/or directly provide such transactions to the accounting software via API. In some embodiments, the integration will enable manual export and automatic export of data in file formats matching those for import in their accounting software. The integration may also offer direct automatic transfer of client data into their accounting system. As another example, the third-party professional may use financial advisory software, such as Addepar, Black Diamond, Orion, Bridge, Advyzon, and others. In such embodiments, the integration module 224 enables the manual or automatic export of data in file formats matching those for import in their advisory software. The integration may also offer direct automatic transfer of client data into their accounting system.

In some embodiments, the integration module 224 is configured to provide integrations with various third-party document storage providers, including Dropbox, Google Drive, Box, OneDrive, etc. In some embodiments, the integration module 224 is configured to automatically save documents, for example, in one or more third-party document storage providers.

In some embodiments, the integration module 224 is configured to provide integrations with payroll providers such as Paychex, Sure Payroll, ADP, Gusto, etc. In such embodiments, the integration module 224 enables an investor to setup one-time or automatic recurring contributions to his/her Solo 401k from his/her payroll. For example, if an investor receives monthly W2 payroll processed by a specific payroll provider, the integration module 224 enables the payroll provider to automatically process and transfer the contribution amount into the Solo 401k bank account within the contribution limits. In some embodiments, any profit-sharing contributions to the Solo 401k plan can also be integrated into the payroll provider.

In some embodiments, the communication module 226 is configured for receiving, processing, and transmitting a user command and/or one or more data streams. In such embodiments, the communication module 226 performs communication functions between various devices, including the user computing device 145, the administrator computing device 185, and a third-party computing device 195. In some embodiments, the communication module 226 is configured to allow one or more users of the system, including an investor or third-party professional, to communicate with one another. In some embodiments, the communications module 226 is configured to maintain one or more communication sessions with one or more servers, the administrator computing device 185, and/or one or more third party computing device(s) 195.

In some embodiments, the display module 228 is configured to display one or more graphic user interfaces, including, e.g., an investor user interface. In some embodiments, the display module 228 is configured to temporarily generate and display various pieces of information in response to one or more commands or operations. The various pieces of information or data generated and displayed may be transiently generated and displayed, and the displayed content in the display module 228 may be refreshed and replaced with different content upon the receipt of different commands or operations in some embodiments. In such embodiments, the various pieces of information generated and displayed in a display module 228 may not be persistently stored.

In some embodiments, the display module 228 is configured to display one or more professional-specific graphic user interfaces, including, e.g., a third-party professional user interface for professional service providers, including accountants, financial advisors, capital raisers, attorneys, investment sponsors, real estate agents, and other related third-party professional services providers.

In some embodiments, the display module 228 is configured to provide a “white label” interface for a specific professional service provider, such as an accountant, financial advisor, capital raiser, attorney, investment sponsor, real estate agent, and other related third-party professional service providers. The professional service provider is granted a white label version of the system that can be domain-mapped to serve on their own custom web domain or subdomain. In such embodiments, the display module 228 is configured to adopt the branding and layout preferences provided by the professional service provider, and any investor clients of the provider who are invited to use the system will observe the provider's brand during use. In some embodiments, the display module 228 further adopts functionalities (e.g., a web portal) that assist in the delivery of their services to an investor client or prospective client. In some embodiments, the professional service provider can enable or disable one or more functionality modules for an investor client. For example, if the provider does not want a cryptocurrency investment capability enabled for one or more of their clients, then it can be disabled. Similarly, functionality for any type of investment, account of entity can be disabled. The settings can be applied to the whole white label interface or customized on a per-module, per-client basis, which enables the provider to only offer services related to investments and entities with which he is comfortable and clear to work with in his own internal company compliance.

In some embodiments, a database engine 230 is configured to facilitate the storage, management, and retrieval of data to and from one or more storage mediums, such as the one or more internal databases described herein. In some embodiments, the database engine 230 is coupled to an external storage system. In some embodiments, the database engine 230 is configured to apply changes to one or more databases. In some embodiments, the database engine 230 comprises a search engine component for searching through thousands of data sources stored in different locations.

As shown in FIG. 3, a plurality of databases is included with the application program 200 and each database is in communication with the various components in the application program 200 via the database engine 230. In some embodiments, for example, the platform comprises a user database 300, a TPP database 310, a compliance database 320, an institution database 330, a document database 340, a transaction database 350, and an investment database 360.

In some embodiments, the user database 300 contains stored data related to the users that use the application program 200. In such embodiments, the user database 300 stores usernames, login information, and user profile information, as well as any other information supplied by a user, such as financial or banking account information and payment methods for a subscription service to the system.

In some embodiments, the third-party professional (TPP) database 310 contains stored data and information related to the third-party professional users who are registered with the application program 200. The stored data includes information entered by a third-party professional in connection with their account registration, including their name, the company name, address, contact details, licenses, business information, business logo, etc. The TPP database 310 also contains, for each third-party professional, the information related to clients, including the name the client and any agreements between the client and the professional.

In some embodiments, the compliance database 320 contains stored data related to any limitations on investment creation or specific transactions, whether for all investors or specific investors, based on laws or regulations. For example, after a bank conducts a KYC/KYB (“know your customer; know your business”) process, as required by laws and regulations, the bank will provide the investor with a letter and/or certification. In some embodiments, compliance database 320 is configured to retrievably store regulatory information associated with each conventional and alternative investment available in the system.

In some embodiments, the institution database 330 contains stored data related to any business entities associated with a client, investment, or transactions. Such business entities include, for example, a bank or trust company. Such information can include, for example, the name, address, contact information, service area, money transfer and wiring instructions, etc.

In such embodiments, the document database 340 contains stored data related to any documents prepared or acquired by the system for an investor or professional. In some embodiments, the documents are organized into folders, subfolders, and include tags by entity, custodian, and/or account. For example, after a bank conducts a KYC/KYB (“know your customer; know your business”) process, as required by laws and regulations, the bank will provide the investor with a letter and/or certification, which will be saved in the document database 340.

In some embodiments, the transactions database 350 contains stored data related to the transactions carried out through application platform 200. In some embodiments, the data includes information related to investment transactions and any communications between a user, third-party professional, or banking or trust institution generated as a result of a transaction carried out through application platform 200. In some embodiments, the data relates to information associated with the payment of one or more fees associated with the transaction (e.g., fees the user owes the host company of the application platform 200). In some embodiments, payment data can be organized and retrieved in a manner that is useful for accounting, auditing, trends, averages, or any other purpose.

In some embodiments, the investment database 360 contains stored data related to any conventional or alternative investment options. For example, an investor typically receives a physical or digital binder of documents, oftentimes consisting of hundreds of pages. The documents are used to create, e.g., a self-directed retirement account structure that is ultimately a specialized type of trust or LLC. If the documents are delivered to the investor/client digitally, then such materials may be stored in the investment database 360. In some instances, physical materials would need to be digitized prior to storage.

### Examples

Unless otherwise specified, all functions outlined below are initiated in the application program 200 via the graphical user interface and executed via one or more API calls to various API vendors, such as trust companies, banks, brokers, exchanges, etc., with which an API integration relationship is formed and maintained.

Example (1) Equity and Account Management: Self-Directed IRA Custodian Account. In this embodiment, a trust account is created with a custodian vendor that is a bank or trust company (via API) and registered to the investor's email address. Investor information is delivered from the user database 300, and any information needed by the custodian vendor that is not initially collected will subsequently be collected from the investor via the user interface. Account types include a trust account, IRA, 401(k), Roth IRA, SEP IRA, and Spousal 401(k). Any data or documents already stored in the database will be provided to the custodian vendor for automated or substantially automated anti-money laundering (AML) and/or know your client (KYC) processing. Automatic verification is conducted through application platform 200. The account opening and KYC automated or substantially automated process happens in a matter of seconds to minutes through API functions with the custodian vendor. Investor initiates transactions and checks transaction status. When required, the investor uploads documents. Investor may add beneficiaries and view current beneficiaries. Investor may view and pay invoices related to account maintenance and/or other services. Investor may add bank accounts to link to the custodian account for the purposes of funds transfer between such bank account(s) and custodian account(s). Investor may indicate a wire or check deposit is in transit into the account. Investor may withdraw funds from his custodian account to a bank account to which he has linked. Investor may upload documents related to a company for AML/KYC. Any documents in the system may be downloaded by investor. Investor may add vendors. For example, if the account owns a property, the insurance carrier and property tax agency will be vendors. Investor may pay vendors. Investor may initiate investment transactions to purchase assets such as real estate, precious metals, cryptocurrencies, equities, private placements, notes, etc., using a Direction of Investment (“DOI”). The investor may choose to invest in assets directly with the IRA or to invest the IRA into an LLC which he/she will manage, as described below.

Example (2) Equity and Account Management: Checkbook IRA. In this embodiment, the investor completes an online application in the user interface to provide a desired LLC name. The API calls are used to form the LLC and register a tax ID number (EIN) for the LLC, and the LLC is owned by the IRA account. The IRA funds are invested in the LLC. The investor is the manager of the LLC, which contains his IRA funds. As manager, the Investor has the authority to open bank and investment accounts in the name of the LLC and direct investment transactions. The software prepares the Operating Agreement, which is configured to allow the Investor to electronically sign the documents.

Example (3) Equity and Account Management: Solo 401k. In this embodiment, the investor completes an online application in the user interface to provide information about his/her qualifying business, such as business start date, NAICS code, business structure (e.g., sole proprietorship, LLC, partnership, S Corp, C Corp), business contact information. Investor's business is named as plan administrator and he/she as trustee. No third-party custodian is legally required. The software will draft plan documents according to his/her application, to the specifications of an IRS approved document provided by a vendor. Such plan documents include summary plan description, adoption agreement, trust agreement, and beneficiary designation form. An EIN is registered for the 401k trust. Investor electronically signs the documents. As trustee, the investor has the authority to open bank and investment accounts in the name of the 401k trust and direct investment transactions. When required a form 5500-EZ will be generated by the software using data input by investor via user interface.

Example (4) Banking. In this embodiment, the Investor is able to open a bank account via user interface, in the name of any Solo 401k trust or Checkbook IRA LLC created in Examples (2) or (3). All previously entered and uploaded data is utilized to deliver to the banking API vendor for programmatic account opening. If any required data is not yet collected, it will be collected from Investor via user interface. Each account investor opens will have a routing number and its own unique account number for use with sending and receiving wires and automated clearing house (ACH) transfers. Any data or documents already stored in the database will be provided to the banking vendor for programmatic AML/KYC processing. Automatic verification is conducted through application platform 200. The account opening and KYC programmatic process happens in a matter of seconds to minutes through API functions with the banking vendor. Investor is able to view balances, statements, and transactions. This data is pulled into the user interface via API connections from API banking vendor. Investor is able to add external bank and brokerage accounts for transferring funds to and from banking account provided in user interface. Investor is able to initiate wire transfers and ACH transfers via user interface. Investor may open and manage multiple accounts, such as one account for traditional 401k funds and a second account for Roth 401k funds. Additional accounts may be opened for Spouse participants, such as a Spouse traditional 401k and a Spouse Roth 401k account. For a Solo 401k trust, up to four accounts can be opened and managed. Investor may transfer funds between the accounts of the same entity and participant. Investor may issue bill payments to outside vendors via the user interface. Investor may use remote deposit capture to deposit checks into his account(s) remotely. For example, the mobile app can be used to take a picture of the front and back of the check. The software delivers these images to the banking vendor via API.

Example (5) Brokerage. In this embodiment, Investor is able to open a brokerage account via user interface, in the name of any Solo 401k trust or Checkbook IRA LLC created in Examples (2) or (3). All previously entered and uploaded data is utilized to deliver to the brokerage API vendor for programmatic account opening. If any required data is not yet collected, it will be collected from Investor via user interface. Any data or documents already stored in the database will be provided to the brokerage vendor for programmatic AML/KYC processing. Automatic verification is conducted through application platform 200. The account opening and KYC programmatic process happens in a matter of seconds to minutes through API functions with the brokerage vendor. In some cases, the brokerage vendor may agree to rely upon previously approved AML/KYC provided by the banking vendor in a previous step. Investor is able to view balances, statements, and transactions. This data is pulled into the user interface via API connections from API brokerage vendor. Investor is able to add external bank and brokerage accounts for transferring funds to and from brokerage account provided in user interface. Investor is able to initiate wire transfers and ACH transfers via user interface. Investor may open and manage multiple accounts, such as one account for traditional 401k funds and a second account for Roth 401k funds. Additional accounts may be opened for Spouse participants, such as a Spouse traditional 401k and a Spouse Roth 401k account. For a Solo 401k trust, a limitation on accounts may exist, such as, for example, a limitation that up to four accounts can be opened and managed.

Example (6) Crypto assets. In this embodiment, Investor is able to open a cryptocurrency account via the user interface, in the name of any Solo 401k trust or Checkbook IRA LLC created in Examples (2) or (3). All previously entered and uploaded data is utilized to deliver to the cryptocurrency API vendor for programmatic account opening. If any required data is not yet collected, it will be collected from Investor via user interface. Any data or documents already stored in the database will be provided to the cryptocurrency vendor for programmatic AML/KYC processing. Automatic verification is conducted through application platform 200. The account opening and KYC programmatic process happens in a matter of seconds to minutes through API functions with the cryptocurrency vendor. In some cases, the cryptocurrency vendor may agree to rely upon previously approved AML/KYC provided by the banking vendor in a previous step. Investor is able to view balances, statements, and transactions. This data is pulled into the user interface via API connections from API cryptocurrency vendor. Investor is able to add external bank, brokerage and cryptocurrency accounts for transferring funds to and from cryptocurrency account provided in user interface. Investor is able to initiate wire transfers and ACH transfers via user interface. Investor may open and manage multiple accounts, such as one account for traditional 401k funds and a second account for Roth 401k funds. Additional accounts may be opened for Spouse participants, such as a Spouse traditional 401k and a Spouse Roth 401k account. For a Solo 401k trust, up to four accounts can be opened and managed. In some embodiments, the application platform 200 interacts with accounts and functionality from multiple cryptocurrency API vendors, including exchanges, over the counter (OTC) trading desks, wallets, cold storage vaults, custodians, banks, trust companies, lending platforms, multi-signature vaults, and tax software.

Example (7) Precious Metals. Investor is able to open a precious metals account via user interface, in the name of any Solo 401k trust or Checkbook IRA LLC created in Examples (2) or (3). All previously entered and uploaded data is utilized to deliver to the precious metals API vendor for programmatic account opening. If any required data is not yet collected, it will be collected from Investor via user interface. Any data or documents already stored in the database will be provided to the precious metals vendor for programmatic AML/KYC processing. Automatic verification is conducted through application platform 200. The account opening and KYC programmatic process happens in a matter of seconds to minutes through API functions with the precious metals vendor. In some cases, the precious metals vendor may agree to rely upon previously approved AML/KYC provided by the banking vendor in a previous step. Investor is able to view balances, statements, and transactions. This data is pulled into the user interface via API connections from API precious metals vendor. Investor is able to add external bank and brokerage accounts for transferring funds to and from precious metals account provided in user interface. Investor is able to initiate wire transfers and ACH transfers via user interface. Investor may open and manage multiple accounts, such as one account for traditional 401k funds and a second account for Roth 401k funds. Additional accounts may be opened for Spouse participants, such as a Spouse traditional 401k and a Spouse Roth 401k account. For a Solo 401k trust, a limitation on accounts may exist, such as, for example, a limitation that up to four accounts can be opened and managed.

Example (8) Crowdfunding. The software will integrate with and aggregate multiple crowdfunding platforms as vendors. Such platforms offer investments in private equity, startups, angel investments, pre-IPO shares, tokenized securities, tokenized assets and venture capital investments. Such investments may be structured as equity, debt, convertible notes, Simple Agreements for Future Equity (SAFE), Simple Agreements for Future Tokens (SAFT), any and such other forms of crowdfunding investment deals. Investor is able to open a crowdfunding account via user interface, in the name of any Solo 401k trust or Checkbook IRA LLC created in created in Examples (2) or (3). All previously entered and uploaded data is utilized to deliver to the crowdfunding API vendor for programmatic account opening. If any required data is not yet collected, it will be collected from Investor via user interface. Any data or documents already stored in the database will be provided to the crowdfunding vendor for programmatic AML/KYC processing. Automatic verification is conducted through application platform 200. The account opening and KYC programmatic process happens in a matter of seconds to minutes through API functions with the crowdfunding vendor. In some cases, the crowdfunding vendor may agree to rely upon previously approved AML/KYC provided by the banking vendor in a previous step. Available investments are pulled in from crowdfunding platform(s) via API to be searched and browsed by investor via user interface. Investments from multiple crowdfunding platforms can be aggregated to enable search and browse features (e.g., filter, sort) across investments from multiple crowdfunding platforms. Investor is able to view balances, statements, and transactions. This data is pulled into the user interface via API connections from API crowdfunding vendor. Investor is able to add external bank, brokerage and cryptocurrency accounts for transferring funds to and from crowdfunding account provided in user interface. Investor is able to initiate wire transfers and ACH transfers via user interface. Investor may open and manage multiple accounts, such as one account for traditional 401k funds and a second account for Roth 401k funds. Additional accounts may be opened for Spouse participants, such as a Spouse traditional 401k and a Spouse Roth 401k account. For a Solo 401k trust, up to four accounts can be opened and managed.

Example (9) Retirement Plan Funding. Investor can initiate a rollover to transfer money from existing retirement accounts into the self-directed retirement account structures managed by our software. The software will prepare and fill any necessary documents to initiate the transfer. When possible, the software will initiate a “direct rollover” or “trustee-to-trustee” transfer in which the releasing custodian issues payment directly to the new retirement plan trust. In this case, no distribution is made and there is no need for a subsequent contribution. Instead, the funds will transfer directly from the pre-existing retirement account to the receiving retirement plan. The software will recommend and process the fastest route for such transfers. For example, a brokerage account is often the preferred account in our software to receive rollovers as it will process faster through the Automated Customer Account Transfer Service (ACATS), resulting in the fastest and smoothest transfer process. Investor can calculate his/her maximum possible contribution in the user interface. Investor can process the contributions by transferring the selected amounts from bank accounts, whether from existing external bank accounts or bank accounts already natively created in the software. Investor can calculate a proposed Roth conversion, review the transaction and then proceed to transfer the funds and download the pre-filled tax forms. Investor with a Solo 401k plan can make voluntary after-tax contributions, convert voluntary after-tax contributions to Roth 401k funds, complete an in-plan Roth conversion form and file IRS form 1099-R to document the conversion, all in the user interface. Investor may add an additional step to the above in the form of doing a rollover from the Roth 401k account into a newly created Roth IRA, all within the user interface. The primary benefit of this would be to eliminate Required Minimum Distributions, particularly for investors who are within a few years of the RMD age of 72 or older. Investor may make distributions from this IRA, Checkbook IRA LLC, or Solo 401k funds in the software. The software prepares and files IRS form 1099-R to document the distribution and processes the funds transfer(s) as well.

Example (10) Distributions. An investor can request a distribution from one investment to an individual bank account. In a distribution from IRA account, the funds are transferred from an IRA custodian account to an individual bank account. In a distribution from a checkbook IRA LLC, the funds are transferred from the LLC bank account to an IRA custodian account and then to the individual bank account. In a distribution from a Solo 401k, the funds are transferred from a 401k trust bank account to an individual bank account. In some embodiments, an investor with a Solo 401k may initiate a participant loan in the user interface. In this scenario, the system will enable the investor to calculate the maximum loan amount and the repayment amounts for various loan amounts. The system will then be prompted to select the desired loan amount and repayment schedule. With this information, the system prepares pre-filled loan documents that the investor can sign electronically. The selected loan amount is then transferred from the Solo 401k bank account to a personal account, such as a linked external bank account.

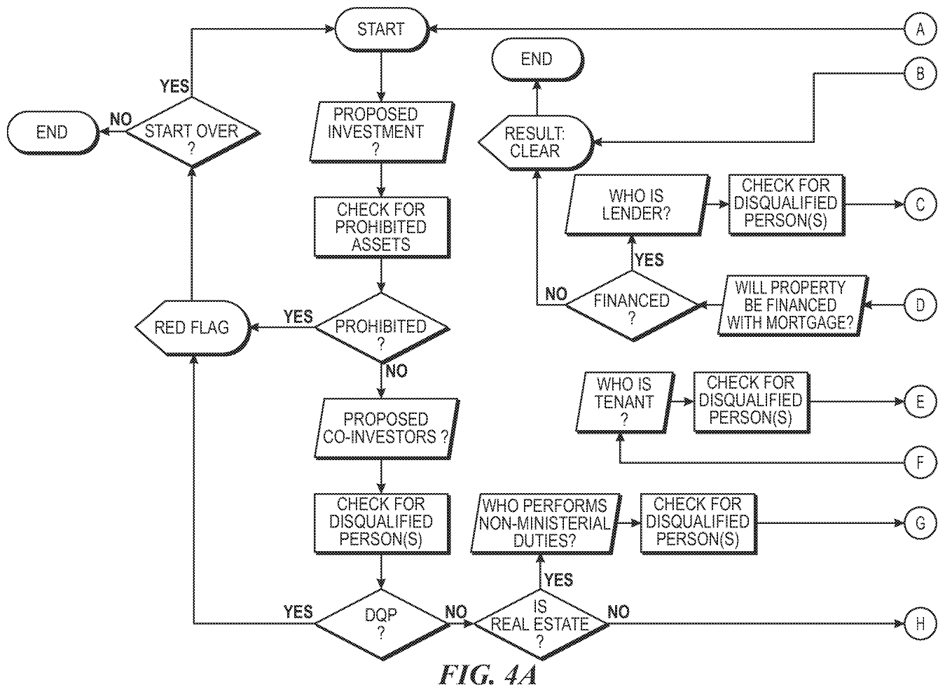

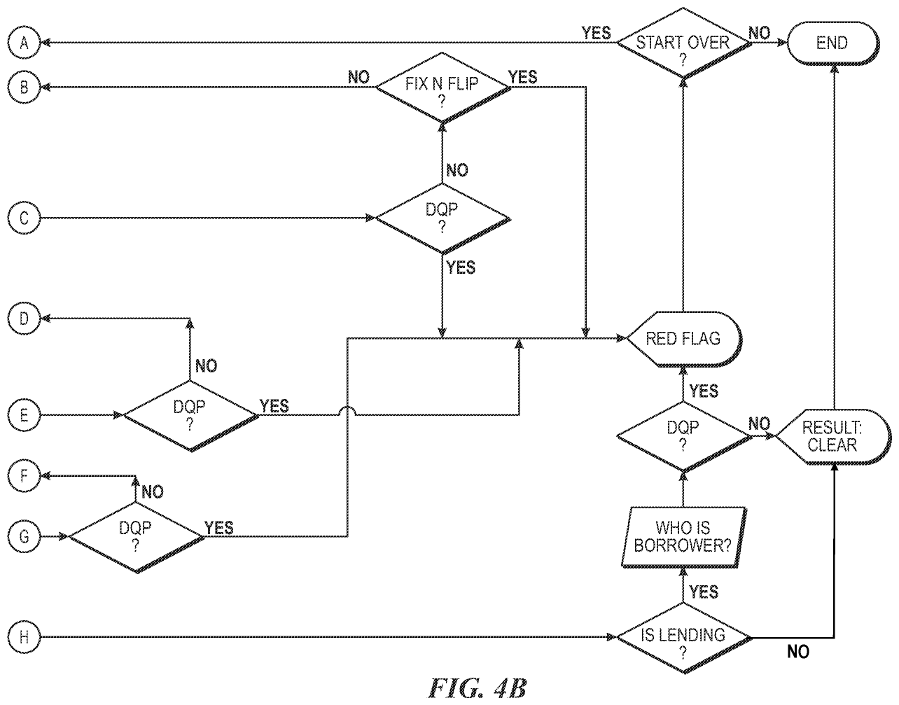

FIG. 4A and FIG. 4B illustrate a flowchart for the compliance process utilized by the embodiments described herein. The system determines if there is a proposed investment and checks for prohibited transactions. If transactions are prohibited, a red flag is triggered and the process starts over or is terminated. If there is no prohibited transaction, the system determines if there are proposed co-investors and checks to ensure the co-investors are not disqualified persons. If the system determines that no co-investors are disqualified persons, the system determines if the transaction is a real-estate transaction. If the transaction is not a real-estate transaction, the system determine if the transaction is a lending transaction and determines the borrower. If the transaction is a real-estate transaction, the system determines who performs non-ministerial duties and checks for disqualified person(s). If there are no disqualified person(s), the system determines who the tenant is and once again checks for disqualified person(s). If there are no disqualified person(s) the system determines if the property will be financed with a mortgage and if it is, who the lender is. Once more the system checks for disqualified person(s) and if there are none, determines if the property is a “fix-and-flip”. If the property is a fix-and-flip, a red flag is triggered, and if it is not a fix-and-flip, the result is CLEAR and the process ends. At any step, if there is a disqualified person(s), the process is ended following a red flag being triggered. In some embodiments, a message is displayed and/or emailed to the relevant user(s) describing the potential compliance violation and possible remedies.

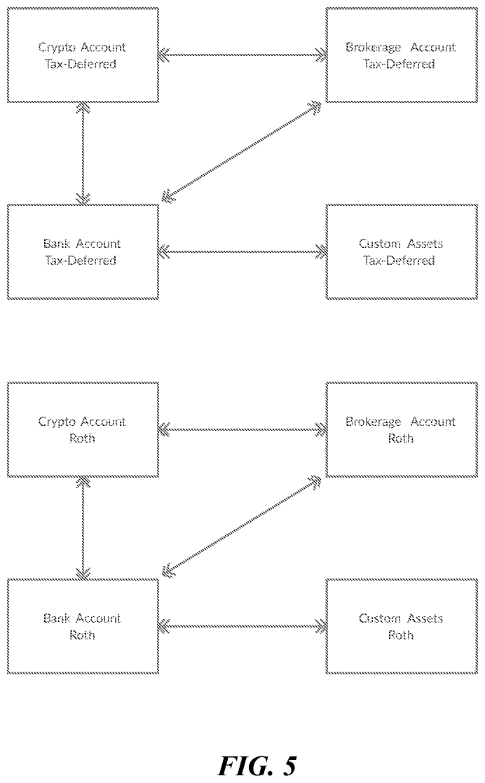

FIG. 5 illustrates a schematic of the funds flow infrastructure, wherein the flow of money between a crypto account tax-deferred, bank account tax-deferred, crypto account Roth, bank account Roth, brokerage account tax-deferred, custom assets tax-deferred, brokerage account Roth, and custom assets Roth is described using arrows to show the flow of funds.

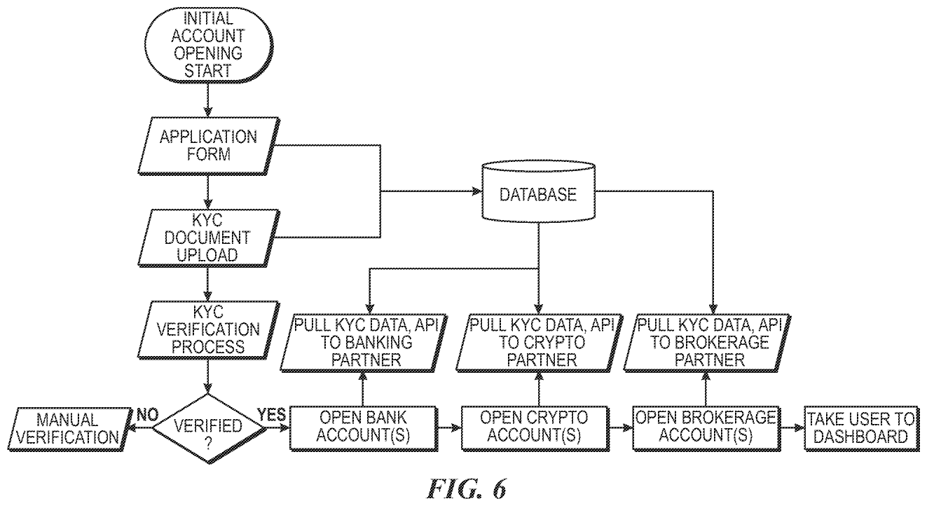

FIG. 6 illustrates a flowchart of the account initiation process. The initial account opening is initiated and an application for is transmitted to a database. The KYC document is uploaded to the database and is verified. If the KYC document cannot be verified, a manual verification is initiated. If the KYC is validated, the bank account(s) is/are opened, and KYC data is pulled to the banking partner API. KYC data is also pulled from the database and transmitted to a crypto partner once crypto accounts are opened. Brokerage accounts are also opened to allow the database to transmit KYC data and transmit it to the brokerage partner API. Lastly, the user is transmitted to the user dashboard to interact with the system.

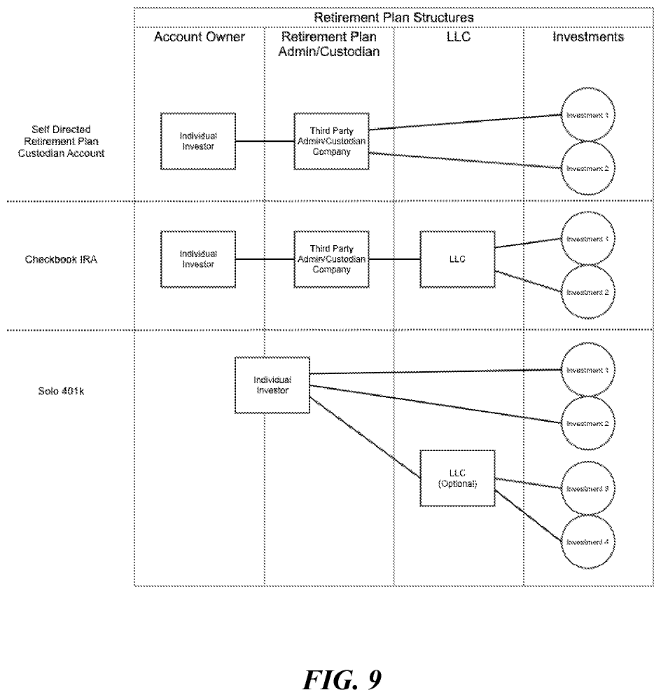

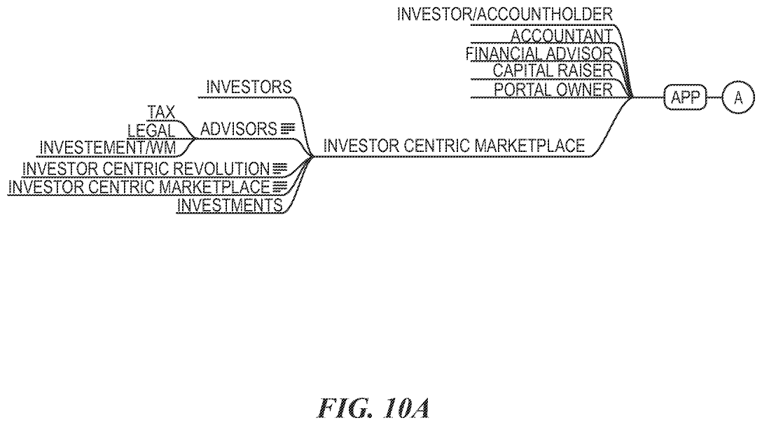

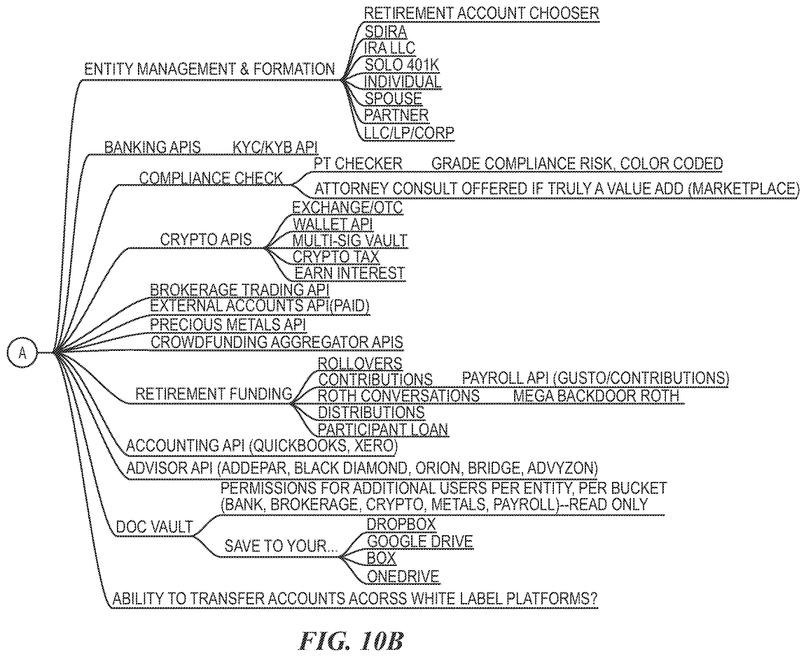

FIG. 9 is a block diagram of the retirement plan structures system wherein the process flow of investments is illustrated for self-directed retirement plan custodian accounts, checkbook IRA's, and solo 401k's. For each, an account owner, retirement plan administrator/custodian, LLC, and investments are indicated. FIG. 10A and FIG. 10B are a map of frontend and backend connections between the application program of FIG. 2 and external systems.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

The term “add-on” or “plug-in” as used herein refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

I/We claim:

1. A system for combining a plurality of financial services in a single investment application for checkbook-controlled retirement plans, the system comprising:
at least one device in operable connection with a network;
an application server in operable communication with the network, the application server configured to host an application system displaying financial information for interacting with a plurality of financial services, the application system having a user interface module for providing access to the application system to the at least one device, the user interface in operable communication with a compliance database to interact with a compliance module, the application system comprising:
an integration module for reading data and transmitting orders for execution to a plurality of financial services, the plurality of financial services for at least one of a natural person, taxable entity, or checkbook-controlled retirement plan; and
a funds transfer module to initiate and execute a transfer of funds between one or more of the plurality of financial services.

2. The system of claim 1, further comprising an investment module configured to facilitate a process for making one or more investments.

3. The system of claim 1, further comprising an LLC (Limited Liability Company) module configured to facilitate the formation and management of an LLC for a user.

4. The system of claim 1, further comprising a conversion module configured to facilitate the conversion of one or more existing pre-tax accounts or Traditional IRAs to a Roth IRA or Roth subaccount of a 401(k) plan.

5. The system of claim 1, further comprising a TPP (Third-Party Professional) module configured to facilitate the creation of a user account for a third-party professional.

6. The system of claim 1, further comprising a TPP white label module configured to provide white label capabilities for professional service providers.

7. The system of claim 1, further comprising a recommendation module configured to generate recommendations for a third-party professional delivered to the advisor for download.

8. The system of claim 1, further comprising a billing module configured to enable a third-party professional to open a professional bank account on the application program to receive fee billing on one or more client assets.

9. The system of claim 1, wherein the compliance module is configured to analyze investment transactions for compliance with one or more laws and regulations.

10. A system for combining a plurality of financial services in a single investment application for taxable entities, natural persons, and checkbook-controlled retirement plans via one or more partnerships with a plurality of API partners, the system comprising:
at least one device in operable connection with a network;
an application server in operable communication with the network, the application server configured to host an application system displaying financial information for interacting with a plurality of financial services, the application system having a user interface module for providing access to the application system to at least one device, the user interface in operable communication with a compliance database to interact with a compliance module, the application system comprising:
an integration module for integrating the plurality of financial services via one or more third party software integrations to enable a third-party professional user interface to include integrations with professional software, wherein the integration module provides one or more preformatted transaction statements and one or more preformatted account statements, the plurality of financial services for at least one of a taxable entity, natural person, or checkbook-controlled retirement plan; and
a funds transfer module to initiate and execute a transfer of funds between one or more of the plurality of financial services,
wherein the compliance module requests an investor to complete a questionnaire to check the compliance of a proposed investment.

11. The system of claim 10, further comprising an investment module configured to facilitate a process for making one or more investments, wherein the investment module further initiates investment transaction to purchase, sell, exchange, and/or swap one or more assets.

12. The system of claim 10, further comprising an LLC (Limited Liability Company) module configured to facilitate the formation and management of an LLC for a user, wherein the LLC module is in communication with a communication module to a completed document to an authority for formation of the LLC.

13. The system of claim 10, further comprising a conversion module configured to facilitate the conversion of one or more pre-tax accounts or Traditional IRAs to a Roth IRA or Roth subaccount of a 401(k) plan.

14. The system of claim 10, further comprising a TPP (Third-Party Professional) module configured to facilitate the creation of a user account for a third-party professional, wherein the user account appears in a browsable and searchable client list provided by the TPP module.

15. The system of claim 14, further comprising a TPP white label module configured to provide white label capabilities for professional service providers.

16. The system of claim 10, further comprising a recommendation module configured to generate recommendations for a third-party professional delivered to the advisor for download, wherein the recommendation engine enables the third-party professional to request the delivery of one or more recommendations to the investor.

17. The system of claim 10, further comprising a billing module configured to enable a third-party professional to open a professional bank account on the application program to receive fee billing on one or more client assets.

18. The system of claim 17, wherein the billing module permits the user to set a billing schedule.

19. The system of claim 10, wherein the compliance module is configured to analyze investment transactions for compliance with one or more laws and regulations.

20. The system of claim 10, further comprising a plurality of databases each in communication with the application program, the plurality of databases including at least one of the following:
a user database to store user data;
a TPP database to store data and information related to the third-party professional users registered with the application program;
a compliance database to store data related to one or more limitations on investment creation or one or more specific transactions;
an institution database to store data related to one or more business entities associated with the client, the investment, or the transactions;
a document database to store data related to one or more documents prepared or acquired by the system;
a transaction database to store data related to one or more transactions carried out via the application program; and
an investment database to store data related to one or more conventional or one or more alternative investment options.
